(19) United States
(12) Patent Application Publication
(10) Pub. No.: US 2006/0265631 A1
(43) Pub. Date: Nov. 23, 2006

(54) Apparatus and method for detecting if a test is running

(76) Inventor: Matthew P. Potts, Citrus Heights, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/084,765

(22) Filed: Mar. 18, 2005

(51) Int. Cl. G06F 11/00

(52) U.S. Cl. 714/48

(57) ABSTRACT

In one embodiment of the invention, a method for detecting if a test case is running, includes: submitting a selected test case as a job into a queuing system; assigning a job name to the job; assigning, by the queuing system, a job number for the job; sending a query regarding the job number in order to obtain a description of a particular job associated with the job number; and if the description indicates that the particular job associated with the job number is running or pending, then matching a particular job name of the particular job with a test name of the selected test case, wherein a match between the particular job name and the test name indicates that the selected test case is running or pending.

### TECHNICAL FIELD

Embodiments of the invention relate generally to testing methods or simulation methods in a test environment, and more particularly to an apparatus and method for detecting if a test is running or if the test will be running in a test environment.

### BACKGROUND

Testing of the designs of electronics devices such as, for example, network switches or other devices, are performed in order to verify the functionalities of the designs and to detect for possible defects. As known to those skilled in the art, test cases are used for testing of the design. A test case is implemented by software code and provides one or more sets of stimulus that is driven into a design-under-test (DUT) so that the design-under-test is tested for correct functionalities and possible defects.

Conventional approaches in the testing of designs suffer from the following disadvantages. First, the conventional approaches often provide incorrect results by providing false positives. In other words, the conventional approaches would show (or indicate) that a job is running, when the job, in fact, is not running. A job is defined as a test case that has already been submitted into a conventional queuing system, so that the test case is in the process of running (or will be in the process of running) for purposes of testing a design-under-test. Second, the conventional approaches often provide incorrect results by providing false negative. In other words, the conventional approaches would show (or indicate) that a job is not running, when the job, in fact, is running.

Therefore, the current technology is limited in its capabilities and suffers from at least the above constraints and deficiencies.

### SUMMARY OF EMBODIMENTS OF THE INVENTION

In one embodiment of the invention, a method for detecting if a test case is running, includes: submitting a selected test case as a job into a queuing system; assigning a job name to the job; assigning, by the queuing system, a job number for the job; sending a query regarding the job number in order to obtain a description of a particular job associated with the job number; and if the description indicates that the particular job associated with the job number is running or pending, then matching a particular job name of the particular job with a test name of the selected test case, wherein a match between the particular job name and the test name indicates that the selected test case is running or pending.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a system (apparatus), in accordance with an embodiment of the invention.

FIG. 2 is a block diagram of a system (apparatus), in accordance with another embodiment of the invention.

FIG. 3 is a flowchart of a method, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

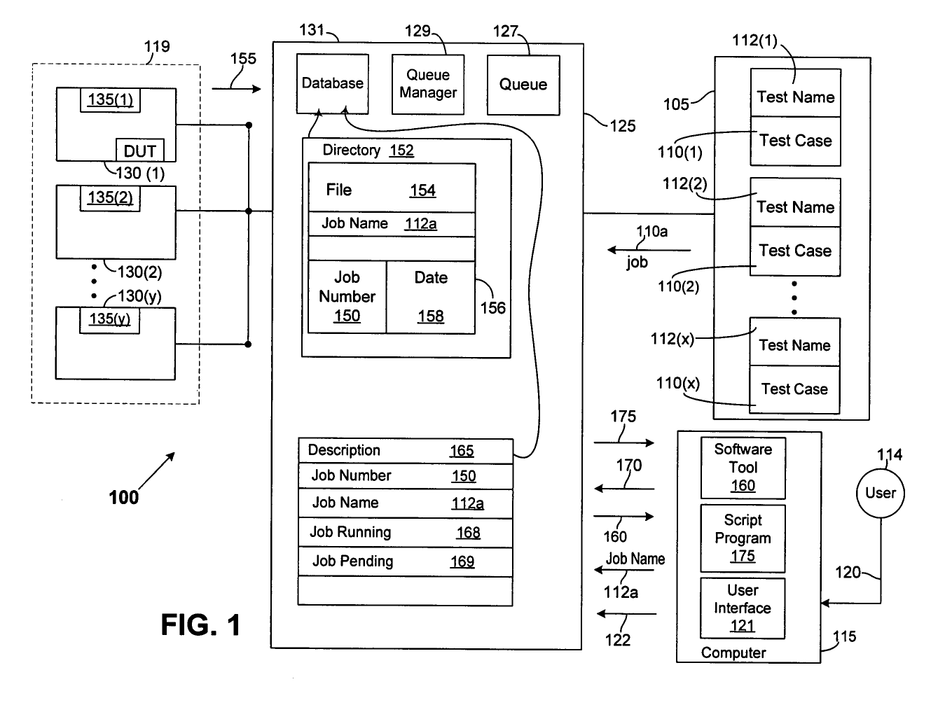

FIG. 1 is a block diagram of a system (apparatus) 100 for detecting if a test case (i.e., test) is currently running in a test environment, or if the test case is pending (i.e., the test case is not currently running, but will be running in a test environment). The system 100 detects if the test case is being run (or will be run) in response to a command from one or more users via a computer (e.g., user computer).

The system 100 includes a device 105 which may be, for example, a storage device, a computing device, or another suitable device that can store one or more test cases (generally referred to as test cases 110). In the example of FIG. 1, the device 105 currently stores the test cases 110(1), 110(2), through 110(x), where x can be any suitable positive integer value. Therefore, the test cases 110 stored in the device 105 can be one or more test cases 110. The test cases 110(1), 110(2), through 110(x) have the test names 112(1), 112(2) through 112(x), respectively. These test names 112(1) through 112(x) are known to the user 114 of a computer 115. In the example discussed in detail below, the test name 112(1) of test case 110(1) is “[NCPU]_{—}1518U_MODEF”, although other suitable test names may be used in other examples or if the test case 110(1) provides a different stimulus for testing a design-under-test.

Each test case 110 is implemented as a standard software code that provides stimulus for testing a design-under-test (DUT) (e.g., DUT 117) in a test environment 119. Each test case 110 provides a stimulus that is driven into a design-under-test 117 in the test environment 119, so that testing is performed on the design-under-test 117 for proper functionalities and possible defects. The user 114 will use the computer 115 in order to select one or more test cases 110 for testing one or more designs-under-test 117 in the test environment 119. It is noted that other users in the system 100 can use other computers (not shown in FIG. 1) in order to select one or more test cases 110 for testing one or more designs-under-test 117 in the test environment 119. Also, in the example of FIG. 1, the design-under-test 117 is shown as only being present in a resource 130(1). However, the design-under-test 117 may be present in other resources in the test environment 119. Additionally, more than one design-under-test 117 may be present in the test environment 119.

In the example discussed herein, assume that the user 115 selects the test case 110(1) for testing the design-under-test 117. However, as mentioned above, the user 114 can select one or more test cases 110 for testing the design-under-test 117 in the test environment 119. The user 114 selects the test case 110(1) by providing a command 120 that is received and processed by a user interface 121 of the computer 115. The computer 115 sends a command 122 to a queuing system 125, and in response to the command 122, the queuing system 125 will obtain and placed into a queue 127 the selected test case 110(1). The queue 127 may be, for example, a memory storage space or a memory buffer. In other implementations of the queuing system 125, the queue 127 is part of the database 131 which is discussed further below. Note that the user 114 and/or other users can select additional test cases 110 for testing the DUT 117, although in this example, the test case 110(1) is the only selected test case for testing the DUT 117, for purposes of clearly describing the operation of embodiments of the invention.

The queuing system 125 will then distribute the queued test case 110(1) to one or more resource (generally referred to as resource 130) in the test environment 119. For example, the resources 130 are computers that are used for testing a design-under-test 117. In the example of FIG. 1, the resources 130 are shown specifically as resources 130(1), 130(2), through 130(y), where y can be any suitable positive integer value. However, the number of resources 130 in the test environment 119 may vary.

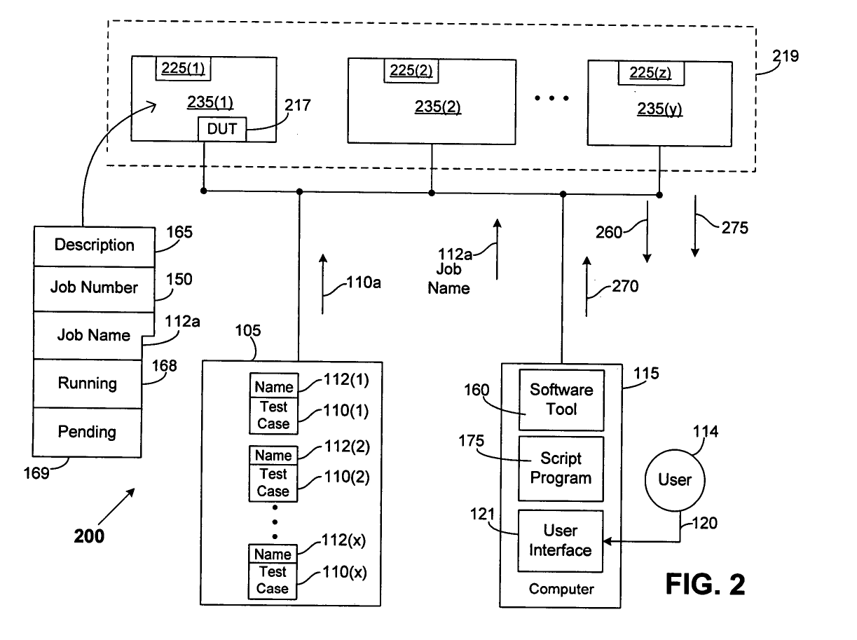

The system 100 in FIG. 1 is a hub-based queuing system, where one or more resources 130 communicates with the queuing system 125, so that any particular one of the resources 130 can run the jobs 110a for testing a design-under-test 117 that is stored in the particular resource 130. If the system 100 is a hub-based system, then the queuing system 125 is typically implemented by a suitable computing device such as, for example, a server or another suitable type of computing device, and the computing device will not run the jobs 110a for testing a design-under-test 117. In the alternative embodiment shown in FIG. 2, the system 200 is a distributed system, where a computing device can queue the jobs and also run the jobs for testing a design-under-test 217, as discussed further below. A job 110a is defined as a test case 110 that has already been submitted into a queuing system 125, so that the test case 110 is in the process of running (or will be in the process of running) for purposes of testing a design-under-test 117. The test case 110 which has already been submitted into the queuing system 125 is also referred herein as a “submitted test case”. More than one job 110a can be submitted into and queued into the queuing system 125. In the example discussed herein, only one job 110a has been submitted into the queuing system 125 for purposes of clearly describing the operation of an embodiment of the invention. One or more jobs 110a can be run (i.e., executed) in a resource 130 so that a design-under-test 117 is tested for proper functionalities and possible defects.

The queuing system 125 includes a queue manager 129 which is software that will queue the jobs 110a to be run on a resource 130 in order to test a design-under-test 117. The queue manager 129 manages the resources 130 that will run the jobs 110a. The queue manager 129 also manages a database 131 that indicates all resources 130 that are available for executing the jobs 110a. The queue manager 129 uses the database 131, for example, to track the memory space and disk space in the resources 130, the network connections between the resources 130 and the queuing system 125, the network connections between the resources 130, and other information for managing the resources 130. For example, if there are fifty users 114, fifty resources 130 that can run jobs 110a, and fifty jobs 110a to be run, then the queue manager 129 will make sure that all of the fifty jobs 110a are executed among the fifty resources 130. The queue manager 129 can be any suitable commercially available queue manager. One example of a suitable queue manager is of the type known as LSF which is commercially available from PLATFORM COMPUTING INCORPORATED, Markham, Ontario, Canada.

Note also that when the user 114 selects the test case 110(1) for testing the design-under-test 117 and the test case 110(1) is submitted as the job 110a into the queuing system 125, the user 114 can assign a job name 112a to the job 110a. The user 114 can assign a job name 112a by providing another command 120 into the user interface 121 of the computer 115, and the computer 115 will transmit the job name 112a into the queuing system 125 so that the queue manager 129 will assign (i.e., associate) the job name 112a to the job 110a. For purposes of simplifying the operation of the system 100 for the user 114, the user 114 typically assigns the job name 112a to be the same name as the test name 112. Therefore, in the example discussed herein, the job name 112a and the test name 112(1) each will have the name “[NCPU]_{—}1518U_MODEF”. The job name 112a for the job 110a is stored in the database 131.

Each resource 130 includes a queue client software (generally referred to as software 135) that communicates with the queue manager 129 in the queuing system 125. In the example of FIG. 1, the resources 130(1), 130(2), through 130(y) include a queue client software 135(1), 135(2), through 135(y), respectively. The queue client software 135 is usually provided as part of the commercially available queue manager product.

The system 100 also typically includes other components that are known and are used for permitting functions and data transmission in a network. For example, each computing device (e.g., resources 130, queuing system 125, and user computer 115) includes a processor (e.g., central processing unit) for executing software or firmware in the computing device. For purposes of focusing on the embodiments of the invention, these other known components are not shown in FIG. 1 and are not necessarily described herein.

One problem with conventional systems is that the test cases are tracked on a machine-basis, and are not tracked on a test-case-basis. Therefore, a user will not know if a test case is currently running or is not running in a test environment. Therefore, the user can encounter the problems of false positives and/or false negatives as mentioned above.

A further problem with conventional systems is that the job numbers are reused because job numbers are limited in number. Therefore, the same job number may be assigned for a first test case, and the same job number may then be used for a second test case and perhaps other test cases. Therefore, if a user is aware that a particular job number is assigned to a test case that is currently being run, the user is not aware of which particular test case is actually being run. The user is only aware that the particular job number is currently being run. An embodiment of the invention advantageously overcomes the above deficiencies of conventional systems, as discussed below.

In the example operation being described herein, the user 114 had selected the test case 110(1) for submission into the queuing system 125. The test case 110(1) is sent to the queuing system 125 as a job 110a. Note that additional test cases 110 can be submitted as additional jobs 110a to the queuing system 125. After the queuing system 120 receives the job 110a in this example, the queue manager 129 will place the job 110a into the queue 127. The queue manager 129 will then assign a job number 140 for the job 110a. Note that the user 114 had already assigned a job name 112a to the job 110a. A directory 152 is associated with the queued job 110a. The directory 152 is stored in the database 131. For example, the directory 152 may be named as “testname.run”, although other names may be given to the directory 152. The queue manager 129 may create the files 154 in a directory 152. The queue manager 129 knows which directory to use, because it is the directory that the job is submitted from (i.e., it is the “current” directory when the submit command is run from the command line).

The directory 152 includes one or more files 154, where the queue manager 129 creates a separate file 154 for each job 110a that is queued in the queuing system 125. In the example of FIG. 1, since only one job 110a has been queued in the queuing system 125, there will be only one file 154 in the directory 152. As an example, the file 154 is named RT_{—}16055.

Note also that usually there is a one-to-one correspondence between the tests and the “run” directories, as well as a one-to-one correspondence between the “run” directories and the job numbers. However, in some cases there will be “orphaned” jobs (i.e., jobs that did not complete or exit properly), and then the queuing system 125 may leave files around in the directory that correspond to older jobs (with different job numbers).

The file 154 will include information in a line (referenced as 156) written by the queue manager 129, where the line 156 indicates the job number 150 assigned for a job 110a, and the date 158 of submission of the job 110a into the queuing system 125. For example, the line 156 indicates job_{—}603840 submitted on a particular date (e.g., month/day/year). The number 603840 is the job number 150 of the job 110a. The file 154 in the directory 152 will also indicate the job name 112a of the job 110a. As discussed above, this job name 112a is assigned by the user 114 to the job 110a. The queue manager 129 will transmit 160 the directory 152 (or information in the directory 152) to the user computer 115. As a result, the user 114 can view (and/or print) in the computer 115 various information such as, for example, the job number 150, date 158, and job name 112a of the job 110a. The computer 115 includes a software tool 160 that communicates with the queuing system 125 and that will receive the information in the directory 152. This information includes a list of one or more job numbers 150 for jobs 110a, where the jobs 110a has been queued in the queuing system 125. The software tool 160 permits the user 114 to view this information in the directory 152. The job name 110a of the job 110a is unique to the test case 110(1) previously submitted to the queuing system 125. The software tool 160 may be written in a suitable known programming language by use of suitable known programming techniques.

The job 110a will eventually run (execute) the test case 110(1) on the resource 130(1) in order to test the design-under-test 117, in this example. The job 110a will communicate with the queue client software 135(1) which will then send a job running confirmation 155 to the queue manager 129 to indicate that the job 110a has started running on the resource 135(1). When the queue manager 129 receives the job running confirmation 155 from the queue client software 135(1), the queue manager 129 will update a description 165 associated with the job 110a with the job number 150. Specifically, the description 165 is updated to indicate that the job 110a is running 168. On the other hand, if the job 110a is queued in the queuing system 125 or has already been transmitted to the test environment 119 but is not yet running, then the description 165 will indicate the job 110a as pending 169, because the queue manager 129 has not yet received and has not yet-processed the job running confirmation 155 from the queue client software 135(1).

The description 165 is also stored in the database 131. Each job will have an associated description 165 that indicates information about a job and the status of the job. Therefore, if the queuing system 125 has received multiple jobs 110a, then the database 131 will store a different description 165 associated with each of the jobs 110a.

The user 114 can use the user computer 115 to send a query 170 to the queue manager 129. Some commercially available queue managers permit a user to send queries by using a command (e.g., command “vjobs” in some types of queue managers) and to input the job number (or list of job numbers) into the queue manager. In this example, the user's query 170 will include the job number 150 (job number “603840” in the example of FIG. 1) which was previously received 160 by the user computer 115 from the queuing system 125. This job number 150 is obtained from the information in the directory 152. In response to the user's query 170, the queue manager 129 checks the database 131 for a description 165 of the job 110a associated with the job number 150 (job number “603840” in the example). The description 165 includes the status (running 168 or pending 169) of the job 110a with the job number 150 and the job name 112a which is the same name of the test case 110(1) in this example.

The description 165 indicates if a job 110a is running 168, waiting to be run (pending 169), has completed, or has failed. If a job 110a is pending 169, then the job can start running in the near future. A job 110a might be pending, for example, if another user had submitted the test to run, but the test has not yet started running.

Alternatively, there might not be any description 165 in the database 131, if a job 110a had finished running a significant amount of time ago and a description 165 for the completed job 110a is no longer present in the database 131.

The queue manager 129 will transmit 175 the description 165 to the user computer 115, and the software tool 160 will display the description 165 in the user computer 115. The user 114 can then view in the computer 115 the information in the description 165 to determine if the job 110a is running 168 or pending 169. The user 114 can ignore jobs with status information 165 indicating that the job is not running or is not pending.

For any job 110a with a job number 150 that indicates that the job 110a is running 168 or pending 169, the job name 112a associated with that job 110a is viewed in the description 165. If that job name 112a matches the original test name 112(1) that is known to the user 114, then a match condition is present and the user can conclude that job 110a is running 168 or is pending 169 (i.e., will be running). In the example of FIG. 1, if the job 110a is running 168 or pending 169, then the description 165 will be indicate (e.g., show in the user computer 115) the job name 112a as “[NCPU]_{—}1518U_MODEF” and the job status is shown as running 168 or pending 169. Therefore, an embodiment of the invention provides a circular method for detecting if a test case 110 is running or pending.

A script program 175 may display and/or printout the information in the description 165 after the information in the description 165 is transmitted 175 from the queuing system 125 to the user computer 115. As known to those skilled in the art, a script is a program or sequence of instructions that is interpreted or carried out by another program rather than by the computer processor (as a compiled program is).

FIG. 2 is a block diagram of a system (apparatus) 200, in accordance with another embodiment of the invention. Note that in this alternative embodiment of the invention, the system 200 includes queuing systems 225 that provide a distributed queuing system. Distributed queuing systems are known to those skilled in the art.

In system 200, similar components from FIG. 1 are shown with the same numerals in FIG. 2, for purposes of describing the functionalities of this alternative embodiment of the invention.

The resources 235(1), 235(2), through 235(y) in the test environment 219 will have each have a queuing system software (generally referred to as software 225 and specifically shown in the example of FIG. 2 as software 225(1), 225(2), through 225(z) where z is a suitable integer value). The resources 235 are, for example, computers. The queuing system software 225 in a resource 235 communicates with the queuing system software 225 in the other resources 235. In this example, when a job 110a for a selected test case 110(1) is submitted to a resource 235 for testing a design-under-test 217 (in resource 235(1) in this example), the queuing system software 225 in that resource 235 will communicate with the queuing system software 225 in the other resources 235, in order to determine which of the resources 235 will execute the selected test case 110(1). Note that the other test cases 110(2) through 110(x) can be additionally or alternatively selected for testing the design-under-test 217.

As similarly described above, the user 114 selects the job name 112a for the job 110a to match the test name 112(1) of the submitted test case 110(1). Also, as an example, assume that the queuing system software 225(1) (in resource 235(1)) assigns a job number 150 to the job 110a. The user 114 can use the user computer 115 to send a query 270 that will include the job number 150 which was previously received 260 by the user computer 115 from the queuing system software 225(1). In response to the user's query 270, the queuing system software 225(1) checks a database for a description 165 of the job 110a associated with the job number 150. The description 165 includes the status (running 168 or pending 169) of the job 110a with the job number 150 and the job name 112a which is the same name of the test case 110(1) in this example.

The queuing system software 225(1) will transmit 275 the description 165 to the user computer 115, and the software tool 160 will display the description 165 in the user computer 115. The user 114 can then view (in the computer 115) the information in the description 165 to determine if the job 110a is running 168 or pending 169. The user 114 can ignore jobs with status information 165 indicating that the job is not running or is not pending.

For any job 110a with a job number 150 that indicates that the job 110a is running 168 or pending 169, the job name 112a associated with that job 110a is viewed in the description 165. If that job name 112a matches the original test name 112(1) that is known to the user 114, then a match condition is present and the user can conclude that job 110a is running 168 or is pending 169 (i.e., will be running).

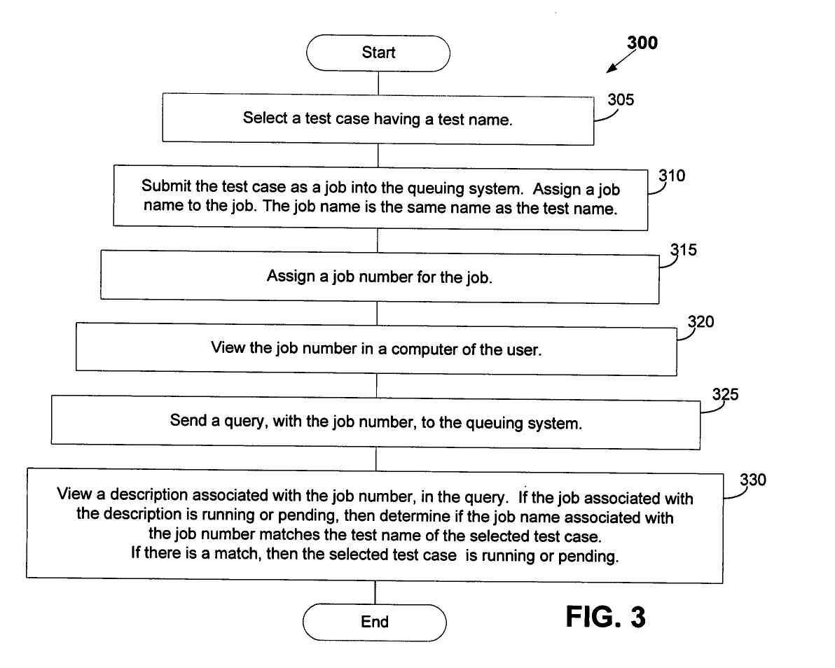

FIG. 3 is a flowchart of a method 300, in accordance with an embodiment of the invention. In block 305, the user selects a test case having a test name. The test case is used to test a design-under-test for proper functionalities and possible defects.

In block 310, the test case is submitted as a job into the queuing system. In block 310, the user also assigns a job name to the job. Typically the job name will be the same name as the test name.

In block 315, the queuing system assigns a job number to the job.

In block 320, the user views the job number in a user computer.

In block 325, the user sends a query, with the job number, to the queuing system.

In block 330, the user views a description associated with the job number in the query. If the job associated with the description is running or pending, then the user determines if the job name associated with the job number matches the test name of the selected test case. If there is a match, then the selected test case is running.

Embodiments of the invention provide a method that initially obtains a test name from a test environment. The job number is logged in the test environment. By providing the job number back into a queuing system, the job description of the job is provided to the queuing system. The job number specifically indicates if the job is currently running and the name of the test. If the test name matches, then the test is running.

Therefore, the above method identifies a job that is running or is pending. The above method also avoids false positives (i.e., avoids showing a job is running, when the job is not actually running). The above method also avoids false negatives (i.e., avoids showing a job is not running, when the job is actually running). Furthermore, the above method advantageously does not rely on the robustness of the simulation for testing the design.

Since job numbers are often reused, the above method circularly follows the job number to ensure that a job number and a test name will have a 1-to-1 (one-to-one) correspondence. The above method also does not depend on the simulation to be robust enough to mark or note whether the simulation is running. Usually, by relying on the simulation environment to detect if the job is running, if the simulation terminates, the job will still appear to be running. The above method solves the above problem.

Various elements in the drawings may be implemented in hardware, software, firmware, or a combination thereof.

The various tools or software discussed herein may be, for example, computer software, firmware, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of an embodiment of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

It is also noted that the various functions, variables, or other parameters shown in the drawings and discussed in the text have been given particular names for purposes of identification. However, the function names, variable names, or other parameter names are only provided as some possible examples to identify the functions, variables, or other parameters. Other function names, variable names, or parameter names may be used to identify the functions, variables, or parameters shown in the drawings and discussed in the text.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for detecting if a test case is running, the method comprising:
submitting a selected test case as a job into a queuing system;
assigning a job name to the job;
assigning, by the queuing system, a job number for the job;
sending a query regarding the job number in order to obtain a description of a particular job associated with the job number; and
if the description indicates that the particular job associated with the job number is running or pending, then matching a particular job name of the particular job with a test name of the selected test case, wherein a match between the particular job name and the test name indicates that the selected test case is running or pending.

2. The method of claim 1, wherein the queuing system is a hub-based queuing system.

3. The method of claim 1, wherein the queuing system is a distributed queuing system.

4. The method of claim 1, further comprising:
queuing the job into the queuing system.

5. The method of claim 1, wherein the job name is assigned to the job by a user.

6. The method of claim 1, wherein the test case provides a stimulus for testing a design-under-test in a test environment.

7. The method of claim 1, wherein the queuing system comprises a computing device.

8. The method of claim 1, further comprising:
checking a database in the queuing system to obtain the description of the particular job associated with the job number in the query.

9. The method of claim 1, wherein the query is sent from a computer in response to a command from a user.

10. The method of claim 1, wherein the test name is known to a user.

11. An apparatus for detecting if a test case is running, the apparatus comprising:
means for submitting a selected test case as a job into a queuing system;
means for assigning a job name to the job;
means for assigning, by the queuing system, a job number for the job;
means for sending a query regarding the job number in order to obtain a description of a particular job associated with the job number; and
means for matching a particular job name of the particular job with a test name of the selected test case, wherein the description indicates that the particular job associated with the job number is running or pending, and wherein a match between the particular job name and the test name indicates that the selected test case is running or pending.

12. An apparatus for detecting if a test case is running, the apparatus comprising:
a device configured to store at least one test case;
a queuing system configured to receive the test case as a job and to assigning a job number for the job; and
a computer configured to receive a query regarding the job number in order to obtain a description of a particular job associated with the job number;
wherein if the description indicates that the particular job associated with the job number is running or pending, and wherein if a match occurs between a particular job name of the particular job and a test name of the test case, then the test case is running or pending.

13. The apparatus of claim 12, wherein the queuing system is a hub-based queuing system.

14. The apparatus of claim 12, wherein the queuing system is a distributed queuing system.

15. The apparatus of claim 12, wherein the queuing system is configured to queue the job.

16. The apparatus of claim 12, wherein the job name is assigned to the job by a user.

17. The apparatus of claim 12, wherein the test case provides a stimulus for testing a design-under-test in a test environment.

18. The apparatus of claim 12, wherein the queuing system comprises a computing device.

19. The apparatus of claim 12, wherein the queuing system is configured to check a database to obtain the description of the particular job associated with the job number in the query.

20. The apparatus of claim 12, wherein the query is sent from a computer in response to a command from a user.

21. The apparatus of claim 12, wherein the test name is known to a user.
